(19) United States
(12) Patent Application Publication
(10) Pub. No.: US 2024/0354547 A1
(43) Pub. Date: Oct. 24, 2024

(54) RFID AUXILIARY ANTENNA, RFID COMMUNICATION APPARATUS, AND RFID COMMUNICATION SYSTEM

(71) Applicant: Murata Manufacturing Co., Ltd., Nagaokakyo-shi (JP)

(72) Inventors: Hiromi MURAYAMA, Nagaokakyo-shi (JP); Tsuyoshi SUESADA, Nagaokakyo-shi (JP); Yoichi SAITO, Nagaokakyo-shi (JP); Noriyuki UEKI, Nagaokakyo-shi (JP)

(21) Appl. No.: 18/761,778

(22) Filed: Jul. 2, 2024

Related U.S. Application Data
(63) Continuation of application No. PCT/JP2022/045646, filed on Dec. 12, 2022.

(30) Foreign Application Priority Data
Jan. 11, 2022 (JP) 2022-002032

(51) Int. Cl. G06K 19/077; G06K 19/07; H01Q 1/22; H01Q 7/00

(52) U.S. Cl. CPC G06K 19/07794; G06K 19/0723; G06K 19/07783; G06K 19/07786; H01Q 1/2208; H01Q 7/00

(57) ABSTRACT

An RFID auxiliary antenna is coupled both with an RFID tag antenna provided for an RFID tag attached to an article and with an RFID antenna. The RFID auxiliary antenna includes a conductor loop to be magnetically coupled with the coil antenna, a dipole antenna, and the capacitor which has the capacitance which resonates with the inductance of the conductor loop. This configuration obtains an RFID auxiliary antenna for placing RFID tags and an RFID antenna under a high degree of freedom of a positional relationship, an RFID communication apparatus including such an auxiliary antenna, and an RFID communication system using the RFID communication apparatus.

### CROSS REFERENCE TO RELATED APPLICATIONS

This application is a continuation of International Application No. PCT/JP2022/045646, filed Dec. 12, 2022, which claims priority to Japanese Patent Application No. 2022-002032, filed Jan. 11, 2022, the entire contents of each of which are hereby incorporated in their entirety.

### TECHNICAL FIELD

The present disclosure is directed to an RFID auxiliary antenna that improves read-write characteristics of an RFID tag by an RFID communication apparatus, the RFID communication apparatus including such an auxiliary antenna, and an RFID communication system using the RFID communication system.

### BACKGROUND OF THE INVENTION

Each article is provided with an RFID tag in order to manage individual article information such as the manufacturing history of a large number of articles and improve traceability. An RFID communication apparatus communicates with the RFID tag and performs reading and writing to the RFID tag.

The RFID tag embedded in an article requires a reduction in size. Therefore, an antenna provided with the RFID tag also has to be reduced in size.

However, in a case in which a small magnetic field antenna such as a coil antenna, for example, is provided with the RFID tag, an electric field radiation type antenna (such as a patch antenna or a dipole antenna, for example) provided with a general reader apparatus used at a factory or the like is difficult to communicate with the magnetic field antenna. Therefore, although a magnetic field-coupled RFID antenna is proximally placed so as to be magnetically coupled with the coil antenna of the RFID tag, a communication distance is short and directivity is also limited. In such a case, it is difficult to add an RFID communication system to an existing manufacturing line.

Accordingly, Japanese Patent No. 6390824 (the “'824 Patent”), for example, discloses an auxiliary antenna that enables communication between a small antenna of an RFID tag and an antenna of a reader apparatus without the necessity of using a small antenna as the antenna (an RFID antenna) of the reader apparatus. This auxiliary antenna includes a resonance loop group in which a plurality of resonance loops having a resonant frequency corresponding to a communication frequency are arranged so as to be magnetically coupled with each other and is configured so that an antenna area of the resonance loop group may be larger than an antenna area of the RFID tag antenna and may be equal to or larger than an antenna area of the antenna of the reader apparatus.

The auxiliary antenna disclosed in the '824 Patent, since being interposed between the antenna of the RFID tag and the antenna (the RFID antenna) of the reader apparatus to cause the RFID tag and the reader apparatus to communicate with each other, enables communication between a small antenna of an RFID tag and an antenna of a reader apparatus without using the small antenna as the antenna of the reader apparatus.

However, in the auxiliary antenna disclosed in the '824 Patent, the auxiliary antenna has to be placed in such a relationship that the RFID tag is coupled with the auxiliary antenna, and the degree of freedom of a positional relationship between the RFID tag and the antenna (the RFID antenna) of the reader apparatus is restricted by the directivity of the auxiliary antenna.

### SUMMARY OF INVENTION

In view of the foregoing, an object of the present disclosure is to provide an RFID auxiliary antenna for placing an RFID tag and an RFID antenna under a high degree of freedom of a positional relationship, an RFID communication apparatus including such an auxiliary antenna, and an RFID communication system using the RFID communication apparatus.

An RFID auxiliary antenna as an example of the present disclosure is an auxiliary antenna to be coupled both with an RFID tag antenna provided for an RFID tag and including a coil antenna and with an RFID antenna, and the auxiliary antenna includes a conductor loop portion to be magnetically coupled with the coil antenna, a dipole antenna portion, and a capacitor that configures a resonant circuit together with an inductance of the conductor loop portion.

An RFID communication apparatus as an example of the present disclosure includes the RFID auxiliary antenna, the RFID antenna, and a communication circuit connected to the RFID antenna, the RFID auxiliary antenna is relatively conveyed in a first direction with respect to the RFID tag antenna, the first direction is same as an extension direction of the dipole antenna portion, and the RFID antenna is a dipole antenna, and the dipole antenna is placed in parallel to the first direction.

An RFID communication system as an example of the present disclosure is configured by the RFID communication apparatus, an article to which the RFID tag including the RFID tag antenna is attached, and a conveying apparatus that conveys the article in the first direction.

### Advantageous Effects of Invention

According to the present disclosure, an RFID auxiliary antenna for placing an RFID tag and an RFID antenna under a high degree of freedom of a positional relationship, an RFID communication apparatus including such an auxiliary antenna, and an RFID communication system using the RFID communication apparatus are able to be obtained.

In some aspects, the techniques described herein relate to an RFID auxiliary antenna being an auxiliary antenna to be coupled both with an RFID tag antenna provided for an RFID tag and including a coil antenna and with an RFID antenna, the auxiliary antenna including: a conductor loop portion to be magnetically coupled with the coil antenna; a dipole antenna portion; and a capacitor that configures a resonant circuit together with an inductance of the conductor loop portion.

### BRIEF DESCRIPTION OF DRAWINGS

In the descriptions that follow, like parts are marked throughout the specification and drawings with the same numerals, respectively. The drawings are not necessarily drawn to scale and certain drawings may be shown in exaggerated or generalized form in the interest of clarity and conciseness. The disclosure itself, however, as well as a mode of use, further features and advances thereof, will be understood by reference to the following detailed description of illustrative implementations of the disclosure when read in conjunction with reference to the accompanying drawings, wherein:

FIG. 1A and FIG. 1B are views showing a structure of an RFID tagged syringe 101 in accordance with aspects of the present disclosure;

FIG. 2 is a plan view of an RFID tag 70 in accordance with aspects of the present disclosure;

FIG. 3 is a cross-sectional view of the RFID tag 70 in accordance with aspects of the present disclosure;

FIG. 4 is a plan view of an RFID auxiliary antenna 201 in accordance with aspects of the present disclosure;

FIG. 5 is a view showing a coupling relationship between conductor loop portions 21, 22, 23, and 24 and dipole antenna portions 26 and 27 in accordance with aspects of the present disclosure;

FIG. 6A is a perspective view showing a positional relationship between the RFID auxiliary antenna 201 and the RFID tag 70 in a coupled state, and FIG. 6B is the front view in accordance with aspects of the present disclosure;

FIG. 7 is a perspective view showing a positional relationship between the RFID auxiliary antenna 201 and a plurality of RFID tags 70A, 70B, 70C, and 70D in accordance with aspects of the present disclosure;

FIG. 8A, FIG. 8B, FIG. 8C, and FIG. 8D are front views showing a positional relationship between the RFID auxiliary antenna 201 and the plurality of RFID tags 70A, 70B, 70C, and 70D at a certain timing in accordance with aspects of the present disclosure;

FIG. 9 is a perspective view showing a positional relationship between the RFID tags 70A, 70B, and 70C, the RFID auxiliary antenna 201, and an RFID antenna 301 in accordance with aspects of the present disclosure; and

FIG. 10 is a perspective view showing a positional relationship between the RFID tags 70A, 70B, and 70C, the RFID auxiliary antenna 201, and an RFID antenna 302 in accordance with aspects of the present disclosure.

### DETAILED DESCRIPTION

Hereinbelow, aspects of the present disclosure will be described below. In a following description of the drawings, the same or similar components will be represented with use of the same or similar reference characters. The drawings are exemplary, sizes or shapes of portions are schematic, and technical scope of the present disclosure should not be understood with limitation to the aspects.

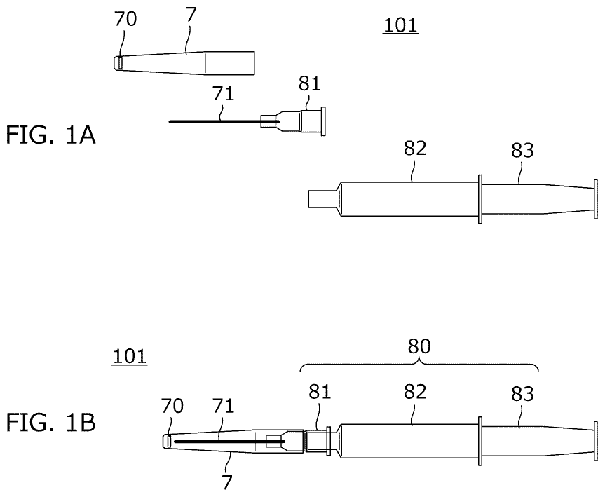

FIG. 1A and FIG. 1B are views illustrating a structure of an RFID tagged syringe 101 in accordance with an aspect of the present disclosure. FIG. 1A is an exploded view of the RFID tagged syringe 101, and FIG. 1B is a front view of the RFID tagged syringe 101.

The RFID tagged syringe 101 is an example of an article to be managed by an RFID tag. This RFID tagged syringe 101 includes a syringe 80, a needle 71 provided with this syringe 80, and a cap 7 that covers this needle 71. The syringe 80 is configured by a cylinder 82, a needle holding portion 81 attached to a tip of the cylinder 82, and a piston 83. The needle holding portion 81 holds the needle 71. The syringe 80 is filled with a chemical substance. More specifically, the cylinder 82 is filled with a chemical substance, and the chemical substance in the cylinder 82 is sealed with a rubber plug. The piston 83, by pushing in the rubber plug, pushes out the chemical substance to a front of the cylinder 82.

The cap 7 is a molded body of an insulating resin, and an RFID tag 70 is integrally molded into the cap 7. The RFID tag 70 is embedded at a position of the tip of the cap 7 in this example.

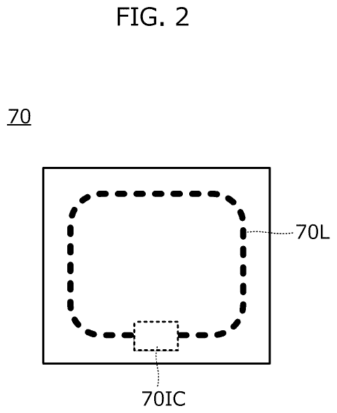

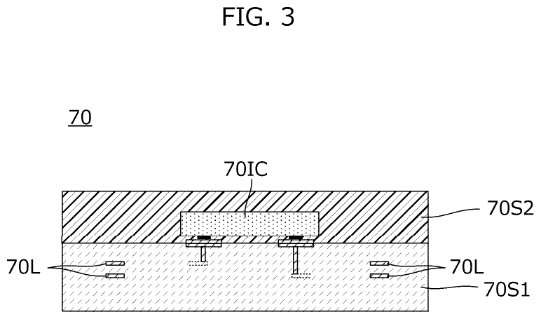

FIG. 2 is a plan view of the RFID tag 70. FIG. 3 is a cross-sectional view of the RFID tag 70. This RFID tag 70 has an RFIC 70IC and a coil antenna 70L. The coil antenna 70L is an RFID tag antenna. A capacitor is provided inside the RFIC 70IC by a capacitor electrode or a parasitic capacitance. A capacitance of this capacitor and an inductance of the coil antenna 70L configure a resonant circuit, and the resonant frequency of this resonant circuit is the communication frequency of the RFID tag, for example, in a range of a 900 MHz band (from 860 MHz to 920 MHz). In short, this RFID tag is an RFID tag using a UHF band.

In FIG. 3, the coil antenna 70L of two turns is provided in a ceramic substrate 70S1. The RFIC 70IC is mounted on the ceramic substrate 70S1. The RFIC 70IC has two terminal electrodes, and one of them is connected to one end of the coil antenna 70L and the other is connected to the other end of the coil antenna 70L. The upper surface of the ceramic substrate 70S1 is covered with a resin insulating layer 70S2, and the RFIC 70IC is protected by this resin insulating layer 70S2.

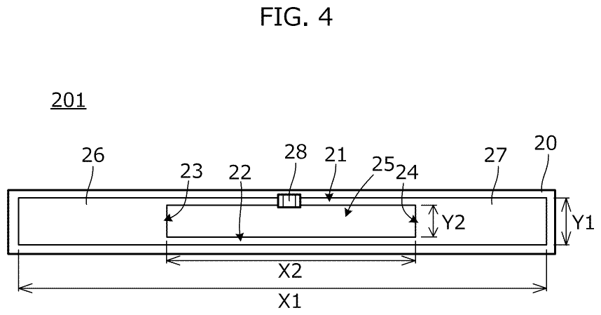

FIG. 4 is a plan view of an RFID auxiliary antenna 201. This RFID auxiliary antenna 201 has conductor loop portions 21, 22, 23, and 24 that are magnetically coupled with the coil antenna 70L of the RFID tag 70. These conductor loop portions 21, 22, 23, and 24 define an opening 25 of the conductor loop portion. In addition, the RFID auxiliary antenna 201 has dipole antenna portions 26 and 27. A capacitor 28 is connected in series at a position along the conductor loop portion 21. A capacitance of this capacitor 28 and an inductance of the conductor loop portions 21, 22, 23, and 24 configure a resonant circuit.

In FIG. 4, a size in the longer direction of the conductor loop portions 21, 22, 23, and 24, that is, a length of the conductor loop portions 21 and 22 is indicated by X2, and a length combining the size X2 of the conductor loop portions 21 and 22 and the dipole antenna portions 26 and 27 is indicated by X1. In addition, a size in the shorter direction of the conductor loop portions 21, 22, 23, and 24, that is, a length of the conductor loop portions 23 and 24 is indicated by Y2, and a length in the shorter direction of the dipole antenna portions 26 and 27 is indicated by Y1. An example of the size of each portion is as follows. X1=150 mm; X2=60 mm; Y1=10 mm; Y2=8 mm

The opening 25 of the conductor loop portion is larger than the coil antenna (the RFID tag antenna) 70L shown in FIG. 2 and FIG. 3, when viewed in a direction perpendicular to a surface of the opening 25 of the conductor loop portion. The size of the coil antenna 70L shown in FIG. 2 and FIG. 3 is, for example, 1.2 mm×1.2 mm. In short, a loop of the coil antenna 70L is inside the opening 25 of the conductor loop portion. It is to be noted that, even when the size in the longer direction of the coil antenna 70L is larger than the size in the shorter direction of the opening 25 of the conductor loop portion, the relationship may be such that the coil antenna 70L is fitted into the opening 25 of the conductor loop portion, when viewed in the direction perpendicular to the surface of the opening 25 of the conductor loop portion. Furthermore, the opening of the coil antenna 70L may overlap with the opening 25 of the conductor loop portion, when viewed in the direction perpendicular to the surface of the opening 25 of the conductor loop portion. In other words, even when the coil antenna 70L is not fitted into the opening 25 of the conductor loop portion, a region with which the opening 25 of the conductor loop portion and the opening of the coil antenna 70L overlap may be present and the coil antenna 70L may extend out of the opening 25 of the conductor loop portion. For more efficient magnetic field coupling, the region with which the opening 25 of the conductor loop portion and the opening of the coil antenna 70L overlap may be increased, such a relationship that the coil antenna 70L may be fitted into the opening 25 of the conductor loop portion is the most efficient.

The resonant frequency of the resonant circuit by the capacitor 28 and the conductor loop portions 21, 22, 23, and 24 is approximately equal to a communication frequency.

The length X1 combining the size X2 of the conductor loop portions 21 and 22 and the dipole antenna portions 26 and 27 is approximately equal to a half wavelength of the communication frequency of a dipole antenna by the dipole antenna portions 26 and 27 and the conductor loop portions 21 and 22. Therefore, this dipole antenna functions as a radiator in the communication frequency.

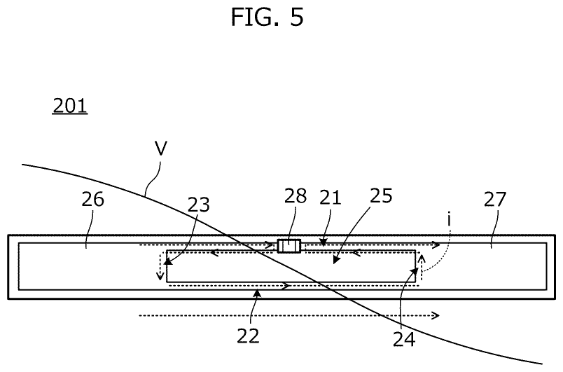

FIG. 5 is a view showing a coupling relationship between the conductor loop portions 21, 22, 23, and 24 and the dipole antenna portions 26 and 27. When a signal is sent from the RFID antenna to the RFID tag antenna, the resonance of the dipole antenna induces a current in the conductor loop portions 23 and 24, and a resonance current i flows in the conductor loop portions 21, 22, 23, and 24.

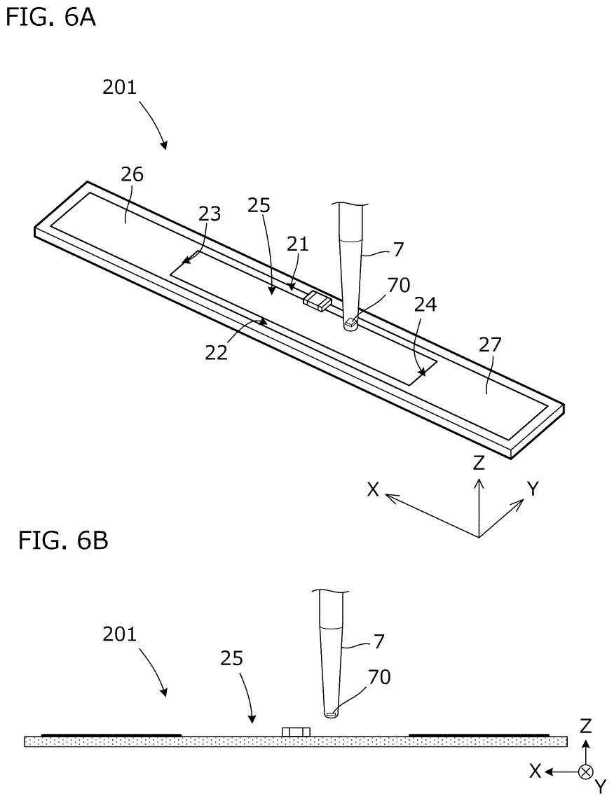

FIG. 6A is a perspective view showing a positional relationship between the RFID auxiliary antenna 201 and the RFID tag 70 in a coupled state, and FIG. 6B is the front view. In FIG. 6A and FIG. 6B, only a part of the cap 7 of the RFID tagged syringes 101 is shown.

In this example, a loop surface of the coil antenna 70L provided in the RFID tag 70 embedded in the cap 7 is in parallel to loop surfaces of the conductor loop portions 21, 22, 23, and 24.

As will be later described, the RFID tagged syringe 101 shown in FIG. 1A and FIG. 1B is conveyed in a first direction (an X direction in the drawing) with respect to the RFID auxiliary antenna 201. This first direction is the same as an extension direction of the dipole antenna portion. In addition, the first direction is the same as the longer direction of the opening of the conductor loop portion.

When the RFID tag 70, viewed in the direction perpendicular to the surface of the opening 25 of the conductor loop portion, is inside the opening 25 of the conductor loop portion, the conductor loop portions 21, 22, 23, and 24 are magnetically coupled with the coil antenna 70L formed into the RFID tag 70.

In a case in which software is configured so that an RFID system can perform substantially simultaneous communication with respect to a plurality of RFID tags 70, the plurality of RFID tags 70 may simultaneously face inside the opening 25 of the conductor loop portion. As a result, an RFID reader-writer is able to communicate with the plurality of RFID tags 70 inside the opening 25 of the conductor loop portion. However, in the example to be described below, a single RFID tag 70 faces inside the opening 25 of the conductor loop portion.

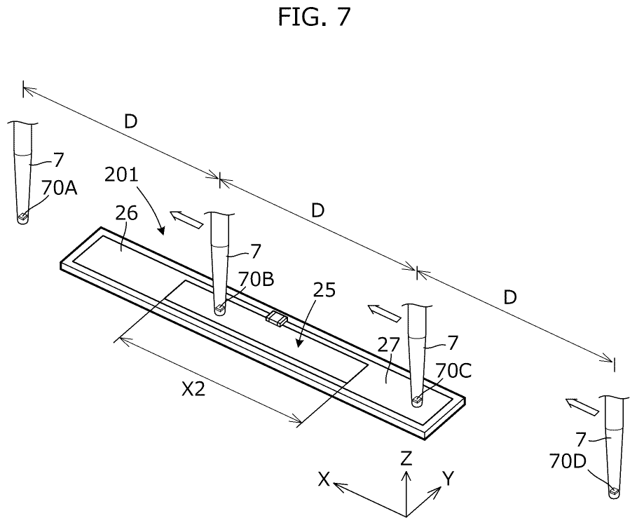

FIG. 7 is a perspective view of an RFID communication system. In addition, this view shows a positional relationship between the RFID auxiliary antenna 201 and the plurality of RFID tags 70A, 70B, 70C, and 70D. The RFID communication system includes a conveying apparatus that conveys a plurality of RFID tagged syringes 101.

In FIG. 7, only a part of the cap 7 of the RFID tagged syringes 101 is shown. In addition, the plurality of RFID tagged syringes 101 are shown to include RFID tags 70A, 70B, 70C, and 70D.

The conveying apparatus of the RFID communication system conveys a large number of RFID tagged syringes 101 in the first direction (the X direction in the drawing) with respect to the RFID auxiliary antenna 201, while keeping a distance D.

The size X2 in the longer direction of the opening of the conductor loop portion is smaller than the placement distance D (that is, the placement distance between the coil antenna of the RFID tags 70A, 70B, 70C, and 70D) of the RFID tagged syringe 101. Therefore, when viewed in the direction perpendicular to the surface of the opening 25 of the conductor loop portion, the plurality of RFID tags among the RFID tags 70A, 70B, 70C, 70D, and the like do not face inside the opening 25 of the conductor loop portion. The RFID tag adjacent to the RFID tag that faces inside the opening 25 of the conductor loop portion faces one of the dipole antenna portions 26 and 27 or does not face the RFID auxiliary antenna 201.

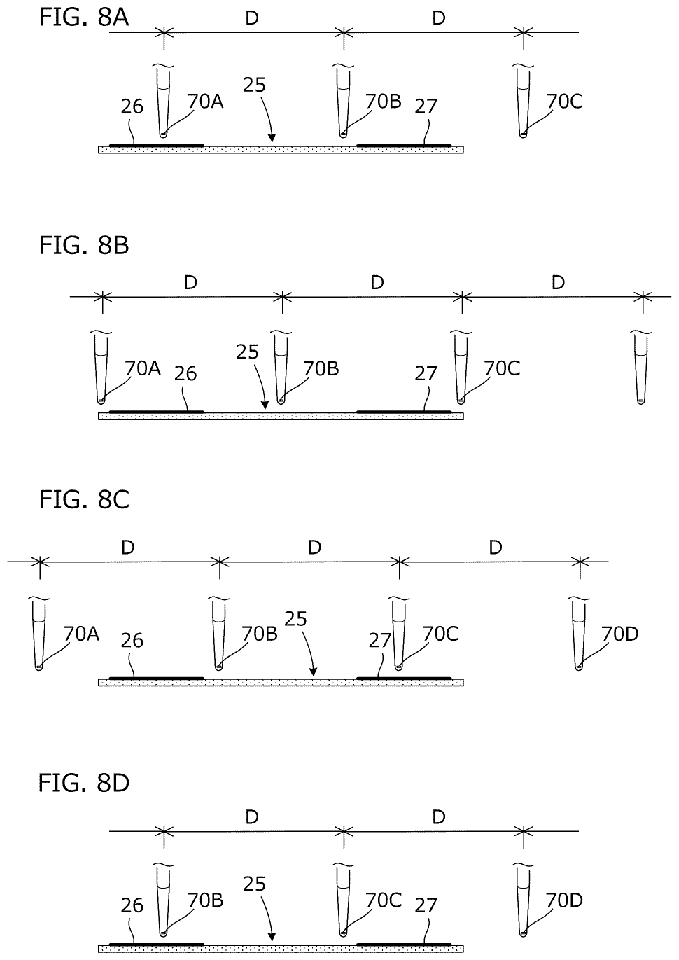

FIG. 8A, FIG. 8B, FIG. 8C, and FIG. 8D are front views showing a positional relationship between the RFID auxiliary antenna 201 and the plurality of RFID tags 70A, 70B, 70C, and 70D at a certain timing. FIG. 8A shows a state in which the RFID tag 70B starts to face inside the opening 25 of the conductor loop portion. At this time, the RFID tag 70A faces the dipole antenna portion 26. The RFID tag 70C and the RFID auxiliary antenna 201 have not yet faced.

Subsequently, when the RFID tags 70A, 70B, 70C, 70D, and the like move to be in a state shown in FIG. 8B, the RFID tag 70B remains facing inside the opening 25 of the conductor loop portion, and the RFID tags 70A and 70C do not face the RFID auxiliary antenna 201.

Subsequently, when the RFID tags 70A, 70B, 70C, 70D, and the like move to be in a state shown in FIG. 8C, the RFID tag 70B remains facing inside the opening 25 of the conductor loop portion, the RFID tag 70C faces the dipole antenna portion 27.

Subsequently, when the RFID tags 70A, 70B, 70C, 70D, and the like move to be in a state shown in FIG. 8D, the RFID tag 70C starts to face inside the opening 25 of the conductor loop portion. At this time, the RFID tag 70B faces the dipole antenna portion 26.

Hereinafter, the RFID tags 70C, 70D, and the like also repeat a state shown in FIG. 8A, FIG. 8B, FIG. 8C, and FIG. 8D.

In a state shown in FIG. 8A, the RFID tag 70B faces inside the opening 25 of the conductor loop portion of the RFID auxiliary antenna 201, so that a conductor loop defined by the conductor loop portions 21, 22, 23, and 24 is magnetically coupled with the RFID tag 70B. The RFID tag 70A faces the dipole antenna portion 26 at this time, so that the RFID tag 70A is shielded by the dipole antenna portion 26. Therefore, the magnetic field coupling between the conductor loop defined by the conductor loop portions 21, 22, 23, and 24, and the RFID tag 70A is blocked.

Although, in the state shown in FIG. 8B, a conductor loop of the RFID auxiliary antenna 201 is magnetically coupled with the RFID tag 70B, since the RFID tags 70A and 70C do not face the RFID auxiliary antenna 201, the conductor loop of the RFID auxiliary antenna 201 does not magnetically couple with the RFID tags 70A and 70C.

In a state shown in FIG. 8C, the RFID tag 70B faces inside the opening 25 of the conductor loop portion of the RFID auxiliary antenna 201, so that the opening 25 of the conductor loop portion defined by the conductor loop portions 21, 22, 23, and 24 is magnetically coupled with the RFID tag 70B. The RFID tag 70C faces the dipole antenna portion 27 at this time, so that the RFID tag 70C is shielded by the dipole antenna portion 27. Therefore, the magnetic field coupling between the conductor loop of the RFID auxiliary antenna 201 and the RFID tag 70C is blocked.

In this manner, when the RFID tag that should be communicated with faces inside the opening 25 of the conductor loop portion of the RFID auxiliary antenna 201, communication with the RFID tag is enabled, and the RFID tag adjacent to the RFID tag, by facing the dipole antenna portions 26 and 27 or being out of the position of the RFID auxiliary antenna 201, does not magnetically couple with the conductor loop of the RFID auxiliary antenna 201, and thus it is possible to avoid unnecessary communication with the RFID tag that should not be communicated with. Accordingly, the software may be configured so that the RFID reader-writer may communicate with only a single RFID tag.

In a case in which the RFID reader-writer has to communicate with the plurality of RFID tags, communication with the plurality of RFID tags, and data processing take time, so that a movement speed (a conveyance speed) of the RFID tagged syringe 101 is restricted. In contrast, as described above, in a case in which the software is configured so that the RFID reader-writer communicates with only a single RFID tag, the configuration of the software is able to be simplified. In addition, since the communication with a single RFID tag is premised, time required for the communication with the RFID tag, and the data processing is able to be reduced. As a result, the movement speed (the conveyance speed) of the RFID tagged syringe 101 is able to be increased, and the processing capacity of the RFID communication system is able to be increased.

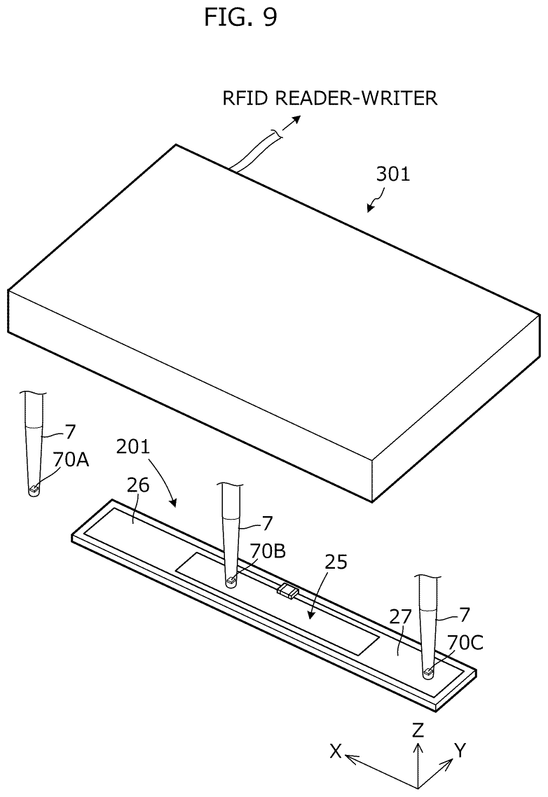

FIG. 9 is a perspective view showing a positional relationship between an RFID communication apparatus configured by the RFID auxiliary antenna 201 and an RFID antenna 301, and the RFID tags 70A, 70B, and 70C that are attached to an article. Although not included in this drawing, the RFID communication apparatus also includes a communication circuit to be connected to the RFID antenna 301. In the RFID antenna 301, a radiation conductor such as a patch antenna or a dipole antenna is provided. The RFID antenna 301 is connected to the RFID reader-writer.

The RFID antenna 301 and the radiation conductor are placed in parallel to the first direction (the X direction). Therefore, the use of the dipole antenna portions 26 and 27 of the RFID auxiliary antenna 201 and the RFID antenna 301 enables communication by electromagnetic waves in a far field. In short, in a state shown in FIG. 9, the communication between the RFID tag 70B and the RFID reader-writer is enabled through the RFID auxiliary antenna 201.

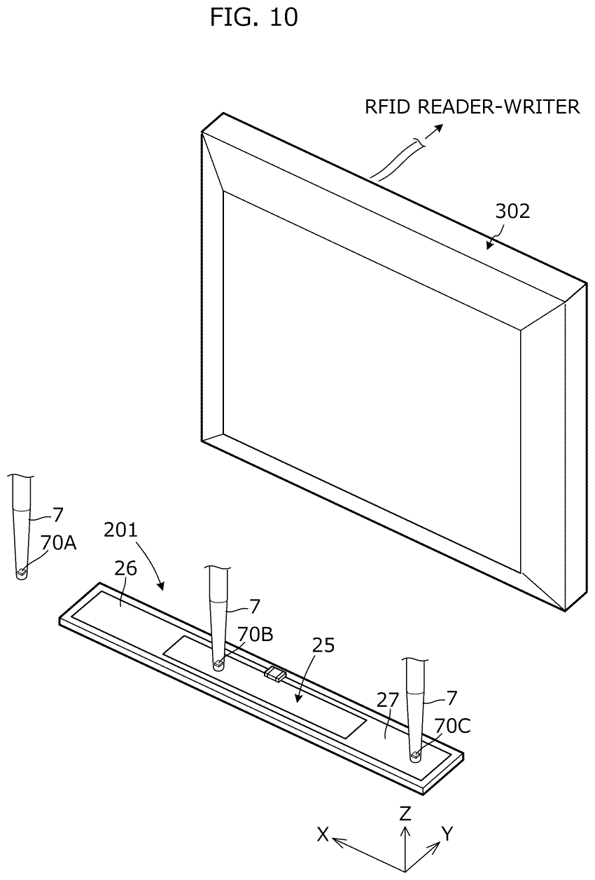

FIG. 10 is a perspective view showing a positional relationship between an RFID communication apparatus configured by the RFID auxiliary antenna 201 and an RFID antenna 302, and the RFID tags 70A, 70B, and 70C that are attached to an article, and is a modification of the RFID communication apparatus shown in FIG. 9. Although not included in this drawing, the RFID communication apparatus also includes a communication circuit to be connected to the RFID antenna 302. In the RFID antenna 302, a planar antenna or a dipole antenna is provided. The RFID antenna 302 is connected to the RFID reader-writer.

The RFID antenna 302 is placed in parallel to the first direction (the X direction). Therefore, the use of the dipole antenna portion of the RFID auxiliary antenna and the RFID antenna 302 enables communication by electromagnetic waves in the far field. In short, in a state shown in FIG. 10, the communication between the RFID tag 70B and the RFID reader-writer is enabled through the RFID auxiliary antenna 201.

As the examples shown in FIG. 9 and FIG. 10, the use of the RFID auxiliary antenna 201 is able to increase a distance from the RFID tag 70B to be read to the RFID antennas 301 and 302. In addition, the RFID antennas 301 and 302 may be placed in parallel to a movement direction of the RFID tagged syringe 101, installation is able to be made in the surrounding 360-degree range in an extension direction with respect to an inspection line to which read-write to the RFID tag is applied, and process design is not limited. In addition, an addition (post-installation) to the existing inspection line becomes easy.

In addition, although FIG. 9 and FIG. 10 show a pair of a single RFID auxiliary antenna 201 and single RFID antennas 301 and 302, a plurality of pairs of the RFID auxiliary antenna and the RFID antenna may be placed along a movement path of the RFID tagged syringe 101, and processing such as reading and writing may be separated.

In addition, reading, writing, and the like of information on the RFID tag may be sequentially performed within a time when an opening portion of a single conductor loop faces the RFID tag.

In addition, the RFID communication system may be configured by use of a plurality of RFID auxiliary antennas 201 and a single RFID antenna. For example, the RFID auxiliary antenna 201 for reading information on the RFID tag and the RFID auxiliary antenna 201 for writing predetermined information to the RFID tag may be provided, and communication through those RFID auxiliary antennas 201 may be performed by a single RFID antenna.

Finally, the present disclosure is not limited to the foregoing exemplary aspects. Various modifications or changes can be appropriately made by those skilled in the art. The scope of the present disclosure is defined not by the foregoing exemplary aspects but by the following claims. Furthermore, the scope of the present disclosure is intended to include all possible modifications or changes from the exemplary aspects within the scopes of the claims and the scopes of equivalents.

For example, although the syringe is an example of an article to be managed in the example shown above, the present disclosure is applicable similarly to other various articles.

In addition, the present disclosure is also applicable to an aspect in which an RFID tagged auxiliary antenna moves in a state in which an article remains still.

In general, the description of the aspects disclosed should be considered as being illustrative in all respects and not being restrictive. The scope of the present disclosure is shown by the claims rather than by the above description and is intended to include meanings equivalent to the claims and all changes in the scope. While preferred aspects of the invention have been described above, it is to be understood that variations and modifications will be apparent to those skilled in the art without departing from the scope and spirit of the invention.

### DESCRIPTION OF REFERENCE SYMBOLS

D—placement distance between RFID tag antennas
i—resonance current
7—cap
21, 22, 23, 24—conductor loop portion
25—opening of a conductor loop portion
26, 27—dipole antenna portion
28—capacitor
70—RFID tag
70A, 70B, 70C, 70D—RFID tag
70IC—RFIC
70L—coil antenna (RFID tag antenna)
70S1—ceramic substrate
70S2—resin insulating layer
71—needle
80—syringe
81—needle holding portion
82—cylinder
83—piston
101—RFID tagged syringe
201—RFID auxiliary antenna
301, 302—RFID antenna

1. An RFID auxiliary antenna being an auxiliary antenna configured to be coupled with an RFID tag antenna provided for an RFID tag and including a coil antenna and with an RFID antenna, the auxiliary antenna comprising:
a conductor loop configured to be magnetically coupled with the coil antenna;
a dipole antenna; and
a capacitor that configures a resonant circuit together with an inductance of the conductor loop.

2. The RFID auxiliary antenna according to claim 1, wherein, when viewed in a direction perpendicular to a loop surface of the conductor loop, an opening of the conductor loop is larger than the RFID tag antenna.

3. An RFID communication apparatus comprising:
the RFID auxiliary antenna according to claim 1;
the RFID antenna; and
a communication circuit connected to the RFID antenna, wherein:
the RFID auxiliary antenna is relatively conveyed in a first direction with respect to the RFID tag antenna;
the first direction is a same direction as an extension direction of the dipole antenna;
the RFID antenna is a planar antenna or a dipole antenna; and
the planar antenna or the dipole antenna is configured parallel to the first direction.

4. The RFID communication apparatus according to claim 3, wherein a length of an opening of the conductor loop in the first direction in a plane of the conductor loop is smaller than a placement distance of the RFID tag antenna.

5. The RFID communication apparatus according to claim 4, wherein a length of the opening of the conductor loop in a second direction perpendicular to the first direction in the plane of the conductor loop is smaller than the length in the first direction.

6. The RFID communication apparatus according to claim 3, wherein an extension direction of the RFID antenna is placed in substantially parallel to an extension direction of the RFID auxiliary antenna.

7. An RFID communication system comprising:
the RFID communication apparatus according to claim 3;
an article to which the RFID tag including the RFID tag antenna is attached; and
a conveying apparatus that conveys the article in the first direction.

8. The RFID communication system according to claim 7, wherein:
the article includes:
a syringe;
a needle configured to be attached to the syringe; and
a cap configured to be attached to the syringe in order to cover the needle; and
the RFID tag is provided at the cap.

9. The RFID communication system according to claim 8, wherein:
the RFID tag is provided at a tip of the cap of the syringe; and
an opening of the coil antenna of the RFID tag is placed in substantially parallel to an opening of the RFID auxiliary antenna.

10. An RFID communication apparatus comprising:
the RFID auxiliary antenna according to claim 1;
the RFID antenna; and
a communication circuit connected to the RFID antenna, wherein:
the RFID auxiliary antenna is relatively conveyed in a first direction with respect to the RFID tag antenna;
the first direction is a same direction as an extension direction of the dipole antenna;
the RFID antenna is a planar antenna or a dipole antenna; and
the planar antenna or the dipole antenna is configured parallel to the first direction.

11. An RFID auxiliary antenna comprising:
a conductor loop configured to be magnetically coupled with an RFID tag antenna;
a dipole antenna; and
a capacitor that configures a resonant circuit together with an inductance of the conductor loop.

12. The RFID auxiliary antenna according to claim 11, wherein, when viewed in a direction perpendicular to a loop surface of the conductor loop, an opening of the conductor loop is larger than RFID tag antenna.

13. The RFID auxiliary antenna according to claim 11, wherein the RFID tag antenna is configured for an RFID tag and includes a coil antenna.

14. An RFID communication apparatus comprising:
the RFID auxiliary antenna according to claim 11;
an RFID antenna; and
a communication circuit connected to the RFID antenna, wherein:
the RFID auxiliary antenna is relatively conveyed in a first direction with respect to the RFID tag antenna;
the first direction is a same direction as an extension direction of the dipole antenna;
the RFID antenna is a planar antenna or a dipole antenna; and
the planar antenna or the dipole antenna is configured parallel to the first direction.

15. The RFID communication apparatus according to claim 14, wherein a length of an opening of the conductor loop in the first direction in a plane of the conductor loop is smaller than a placement distance of the RFID tag antenna.

16. A RFID communication apparatus comprising:
an RFID antenna;
a communication circuit connected to the RFID antenna;
a RFID auxiliary antenna comprising a conductor loop configured to be magnetically coupled with the RFID tag antenna;
a dipole antenna; and
a capacitor that configures a resonant circuit together with an inductance of the conductor loop.

17. The RFID communication apparatus according to claim 16, wherein:
the RFID auxiliary antenna is relatively conveyed in a first direction with respect to the RFID tag antenna;
the first direction is an extension direction of the dipole antenna;
the RFID antenna is a planar antenna or a dipole antenna; and
the planar antenna or the dipole antenna is configured parallel to the first direction.

18. The RFID communication apparatus according to claim 17, wherein a length of an opening of the conductor loop in the first direction in a plane of the conductor loop is smaller than a placement distance of the RFID tag antenna.

19. The RFID communication apparatus according to claim 18, wherein a length of the opening of the conductor loop in a second direction perpendicular to the first direction in the plane of the conductor loop is smaller than the length in the first direction.

20. The RFID communication apparatus according to claim 17, wherein an extension direction of the RFID antenna is parallel to an extension direction of the RFID auxiliary antenna.
